(19) United States
(12) Patent Application Publication
(10) Pub. No.: US 2012/0070754 A1
(43) Pub. Date: Mar. 22, 2012

(54) Fuel Cell with Rapid Pressure Balancing

(76) Inventor: Kenneth Smith, Colfax, WI (US)

(21) Appl. No.: 13/237,650

(22) Filed: Sep. 20, 2011

Related U.S. Application Data
(60) Provisional application No. 61/384,797, filed on Sep. 21, 2010.

(51) Int. Cl. H01M 8/04; H01M 8/10

(52) U.S. Cl. 429/428; 429/535

(57) ABSTRACT

A fuel cell provides for rapid pressure equalization across the proton exchange membrane by means of an expansion chamber on one side of the proton exchange membrane, the expansion chamber communicating with the gas on the other side of the membrane. Changes in size of the expansion chamber adjust pressure more rapidly than external control of flow rates.

### CROSS-REFERENCE TO RELATED APPLICATION

This application claims the benefit of U.S. provisional application 61/384,797 filed Sep. 21, 2010 hereby incorporated by reference.

### BACKGROUND OF THE INVENTION

The present invention relates to a fuel cell for conversion of gaseous fuel into electrical current and, in particular, to a fuel cell design that provides improved pressure regulation of gaseous fuels.

Fuel cells convert chemical fuel into electrical current. A common hydrogen-oxygen, proton exchange membrane (PEM) fuel cell design provides a membrane that blocks gaseous hydrogen and oxygen but that will allow hydrogen protons to past. Electrical conductors are placed on either side of this membrane. On the anode side, a catalyst may disassociate hydrogen into protons and electrons. The protons may pass through the membrane to combine with oxygen on the other side and produce water, while the disassociated electrons are collected by the anode-side electrical conductor and conducted through an electrical conductor to the other side of the membrane to the cathode-side electrical conductor (after passing through a load).

The proton exchange membrane is relatively thin to provide efficient passage of protons and thus susceptible to damage particularly from small pressure differences between the high-pressure gas streams on either side of the membrane.

### SUMMARY OF THE INVENTION

The present invention provides an, improved fuel cell design implementing a simple but high-speed auto balancing of pressure on either side of the proton exchange membrane. One of the gases, for example oxygen in standard air, is applied to a compartment on one side of the membrane and also to a contained bellows in a compartment on the opposite side of the membrane, the latter which also receives the other gas, for example, hydrogen. This bellows, to within the limits of its travel, ensures pressure balance between the two chambers via Pascal's law, by allowing gas flow between the two chambers without intermixing.

Specifically, the present invention provides a fuel cell having a housing with a first and second compartment separated by a proton exchange membrane, the second compartment having a volume defined at least in part by a degree of expansion of an expandable chamber communicating with the second volume. A first and second gas inlet communicate with the first and second compartments to provide one of a fuel and oxidizer into the respective compartment. A gas conduit communicates with the first compartment and the expandable chamber to substantially equalize pressures between the first and second compartment.

It is thus a feature of at least one embodiment of the invention to provide rapid pressure equalization across the proton exchange membrane without the need for complex gas flow regulation. Equalizing the pressure across the membrane increases the life of the membrane and prevents gas exchange which can lead to condensation formation and the like.

The expandable chamber may include a flexible diaphragm providing a shared gas-impermeable dividing wall between the expandable chamber and the second compartment.

It is thus a feature of at least one embodiment of the invention to provide a design that can closely couple the volumes of the second compartment and expansion chamber through a dividing wall.

The flexible diaphragm may be attached to substantially rigid chamber walls forming a remainder of the expandable chamber.

It is thus a feature of at least one embodiment of the invention to provide a simple method of fabricating an expandable chamber.

The flexible diaphragm provides an elastic material that may stretch to accommodate changes in volume of the expandable chamber.

It is thus a feature of at least one embodiment of the invention to permit the use of elastomeric polymers for the formation of the diaphragm.

Alternatively, the flexible diaphragm may provide pleating to permit expansion of the expandable chamber without substantial stretching of the flexible diaphragm.

It is thus a feature of at least one embodiment of the invention to permit an elastic material (e.g. metals) to be used in construction of the expandable chamber.

The flexible diaphragm may provide a peripheral lip compressibly received between open ends of walls of the second compartment and the expandable chamber.

It is thus a feature of at least one embodiment of the invention to provide a simple fabrication method for producing the expandable chamber that sandwiches a flexible diaphragm in between housing walls.

The area of the flexible diaphragm maybe substantially equal to an area of the proton exchange membrane.

It is thus a feature of at least one embodiment of the invention to provide for rapid pressure equalization over the entire area of the proton exchange membrane in contrast to flow control techniques which may allow for a pressure gradient form.

The flexible diaphragm may be substantially coplanar with the proton exchange membrane.

It is thus a feature of at least one embodiment of the invention to provide a low-profile expansion chamber allowing thin fuel cells to be constructed for stacking.

The first and second chambers and expandable chamber may be comprised of: a set of stacking elements providing axial gas flow therethrough and having peripheral front and back lips; a first and second element having opposed front lips fitting against a peripheral region of the proton exchange membrane to seal thereagainst; a first cap fitting against a back lip of the first element opposite the second element to define the first compartment; a third element having a front lip opposed to the back lip of the second element each fitting against a peripheral region of the flexible diaphragm on opposite sides thereof to seal thereagainst, the second element, proton exchange membrane, and flexible diaphragm defining the second compartment; and a second cap fitting against a back lip of the third element, the flexible diaphragm, third element, and second cap defining the expandable chamber.

It is thus a feature of at least one embodiment of the invention to provide a simple fabrication technique employing stackable elements.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a simplified cross-sectional view through a fuel cell per the present invention showing a compartment on one side of a PEM membrane having a flexible bellows wall providing for pressure equalization;

FIG. 2 is a figure similar to that of FIG. 1 showing flexure of the bellows to equalize pressure with over pressure of oxygen or under pressure of hydrogen; and

FIG. 3 is a perspective view of a mechanical implementation of the fuel cell of FIG. 1.

### DETAILED DESCRIPTION OF THE PREFERRED EMBODIMENT

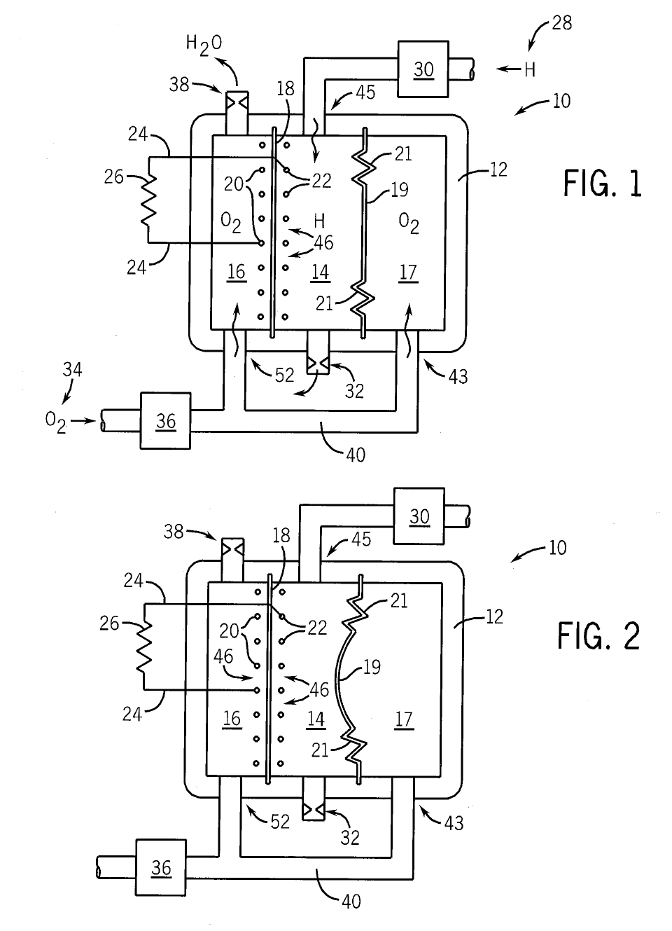

Referring now to FIG. 1, a fuel cell 10 may provide for closed housing 12 separated into a first compartment 14 and second compartment 16 by means of a proton exchange membrane 18 subdividing an enclosed volume of the closed housing 12. The first compartment 14 may be further separated from an expandable chamber 17 by a flexible diaphragm 19 being impermeable to gas.

The proton exchange membrane 18 may be flanked by a first electrode set 22 or the like in the first compartment 14 providing an anode and possibly coated with a catalytic material, and by a second electrode set 20 in the second compartment 16 also coated with a catalytic material. The catalytic material on the first electrode set 22 may be one which breaks down hydrogen into electrons and ions (protons); the anode catalyst may, for example, be a fine platinum powder. The catalytic material on the second electrode set 20 may be one which combines the ions (hydrogen protons) with oxygen, for example one made up of nickel.

The first electrode set 22 and second electrode set 20 are connected by leads 24 to electrical load 26 that may receive power from the fuel cell 10. Generally the anode and cathodes may have a variety and combinations of catalysts including but not limited to platinum, nickel, ruthenium, titanium dioxide, palladium and others.

A source of fuel, for example hydrogen 28, may be received under pressure through a pressure regulator 30 into compartment 14 to pass along the surface of the proton exchange membrane 18 and out of compartment 14 through a metering orifice 32, for example, to a downstream fuel cell 10 (not shown). The pressure regulator 30 may be of conventional design, controlling the flow of the hydrogen 28 as a function of gauge pressure at the inlet to the first compartment 14.

A source of oxygen 34, for example as purified or in air, may be received under pressure through pressure regulator 36 into compartment 16 to pass along the surface of the proton exchange membrane 18 and out a metering orifice 38, for example, also connected to a later fuel cell 10 (not shown). The stream of oxygen from the regulator 36 also is received into expandable chamber 17 and as a result compartment 16 and expandable chamber 17 are interconnected by a low flow resistance passageway 40 to have substantially the same pressure. Again, the pressure regulator 36 may be of conventional design controlling flow of oxygen in response to pressure in the second compartment 16 and expandable chamber 17.

It will be appreciated that the flexibility of diaphragm 19 ensures that the pressure between compartment 14 and expandable chamber 17 are also equal and so that the diaphragm 19 provides for a rapid and self balancing system to ensure that the pressures in compartments 14 and 16 are substantially equal within the range of movement of the diaphragm 19 despite momentary variations in the pressures provided by regulators 30 and 36.

Referring to FIG. 2, movement of the diaphragm 19 away from expandable chamber 17 and toward compartment 14 may occur, for example, if the pressure of oxygen in compartment 16 and expandable chamber 17 increases significantly over the pressure of the hydrogen in compartment 14 such as causes neutralizing diaphragm movement. It will be appreciated that, as a result of equalizing the pressures in compartments 14 and 16, the proton exchange membrane 18 is shielded from lateral forces caused by pressure differences.

The diaphragm 19 may generally be parallel to the proton exchange membrane 18 and of substantially equal area to provide for rapid adjustment of the pressure over the entire surface of the proton exchange membrane 18. Diaphragm 19 may be an elastomeric or stretching material such as a polymeric material that is gas impermeable, and/or may include cleats 21 allowing distention of the diaphragm 19 and expansion of the expandable chamber 17 without substantial stretching of the diaphragm 19 permitting the diaphragm 19 be constructed of thin metal or the like.

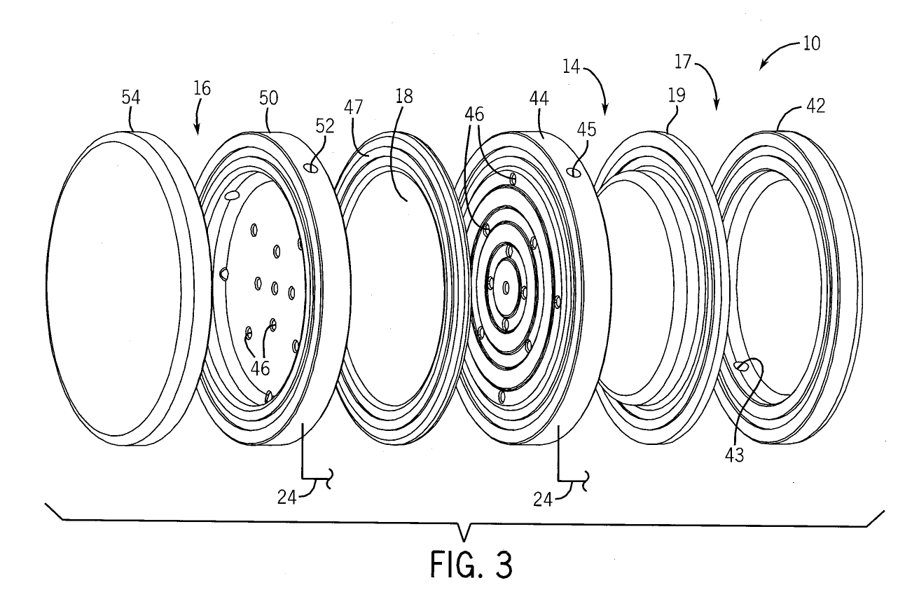

Referring now to FIG. 3, the fuel cell 10 in one embodiment may be readily constructed by assembly of a set of inter-nesting or stackable disks beginning with an end cap 42 being a substantially cylindrical cup receiving at its front lip a rear surface of a peripheral edge of diaphragm 19. The interconnection between the end cap 42 and diaphragm 19 defines expandable chamber 17 and the end cap 42 includes an opening 43 in its sidewall for receiving the oxygen stream as described above.

The outer edge of the front surface of the peripheral edge of the diaphragm 19 may be received by a corresponding rear lip of a current collecting plate 44 being also a cylindrical cup concave toward end cap 42. The interconnection between the current collecting plate 44 and the diaphragm 19 forms the compartment 14. A front surface of the current collecting plate 44 may provide for the function of the first electrode set 22 and may be treated with an appropriate catalyst. The current collecting plate 44 may be electrically conductive and, as will be understood, the current collecting plate 44 is electrically isolated from other elements of the fuel cell 10 and therefore may be attached to a lead 24 for the conduction of electricity. The current collecting plate 44 may provide for a hydrogen port 45 in its lip to receive hydrogen therein and an exit port (not visible in FIG. 3) providing the metering orifice 32.

The current collecting plate 44 includes a set of apertures 46 in its circular face allowing axial flow therethrough, the circular face positioned closely proximate to a first side of a disk-shaped proton exchange membrane 18. The current collecting plate 44 provides a front lip that may sealingly engage with a ring of gasket material 47 on the edge of the proton exchange membrane 18.

A second current collecting plate 50, being essentially the mirror image of current collecting plate 44, has a front lip that attaches to the gasket material 47 on the edge of the proton exchange membrane 18 at an opposite face of the proton exchange membrane 18. This current collecting plate 50 also includes a port 52 for oxygen, entry in a circular lip of the current collecting plate 50 communicating with the port 43. The current collecting plate 50 provides for the function of the second electrode set 20 and therefore may also provide via a conductive body an attachment for a conductive lead 24. This lip of current collecting plate 50 may receive an end cap 54 sealingly engaging a periphery of the lip of the current collecting plate 50 together to define compartment 16.

It will be appreciated that multiple stacks as above described may be positioned along an axis and held together by a compression means such as a clamp or bellows or the like.

It will be understood that a variety of different shapes, materials and designs of the diaphragm 19 is possible including the use of a free standing inflatable diaphragm 19 within the compartment 14 as well as a movable piston between expandable chamber and the second compartment. In addition, the invention may be applicable to fuel cells using liquid fuels and high temperature fuel cells using heat or light activated catalysts.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, the and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What I claim is:

1. A fuel cell comprising:
a housing providing a first and second compartment separated by a proton exchange membrane, the second compartment having a volume defined at least in part by a degree of expansion of an expandable chamber communicating with the second volume;
a first gas inlet communicating with the first compartment to provide one of a fuel and oxidizer into the first compartment;
a second gas inlet communicating with the second compartment to provide an other of the fuel and oxidizer into the second compartment; and
a gas conduit communicating with the first compartment and the expandable chamber to substantially equalize pressures between the first and second compartment.

2. The fuel cell of claim 1 wherein the expandable chamber includes a flexible diaphragm providing a shared gas impermeable dividing wall between the expandable chamber and the second compartment.

3. The fuel cell of claim 2 wherein the flexible diaphragm is attached to substantially rigid chamber walls forming a remainder of the expandable chamber.

4. The fuel cell of claim 2 wherein the flexible diaphragm provides an elastic material that may stretch to accommodate changes in volume of the expandable chamber.

5. The fuel cell of claim 2 wherein the flexible diaphragm provides pleating to permit expansion of the expandable chamber without substantial stretching of the flexible diaphragm.

6. The fuel cell of claim 2 wherein the flexible diaphragm provides a peripheral lip compressibly received between open ends of walls of the second compartment and the expandable chamber.

7. The fuel cell of claim 2 wherein an area of the flexible diaphragm is substantially equal to an area of the proton exchange membrane.

8. The fuel cell of claim 2 wherein the flexible diaphragm is substantially coplanar with the proton exchange membrane.

9. The fuel cell of claim 2 wherein the first and second chambers and expandable chamber are comprised of: a set of stacking elements providing axial gas flow therethrough and having peripheral front and back lips; a first and second element having opposed, front lips fitting against a peripheral region of the proton exchange membrane to seal thereagainst; a first cap fitting against a back lip of the first element opposite the second element to define the first compartment; a third element having a front lip opposed to the back lip of the second element each fitting against a peripheral region of the flexible diaphragm on opposite sides thereof to seal thereagainst, the second element, proton exchange membrane, and flexible diaphragm defining the second compartment; and a second cap fitting against a back lip of the third element, the flexible diaphragm, third element, and second cap defining the expandable chamber.

10. The fuel cell of claim 1 wherein the first compartment includes a first electrode and the second compartment includes a second electrode wherein the first and second electrodes each provide for one of catalytic disassociation of hydrogen electrons and protons and catalytic combination of oxygen and hydrogen protons.

11. The fuel cell of claim 10 wherein the first compartment receives oxygen and the second compartment receives hydrogen.

12. The fuel cell of claim 1 further including a first gas outlet communicating with the first compartment to exhaust at least one of unused fuel and oxidizer out of the first compartment; and
a second gas outlet communicating with the second compartment to exhaust at least one of an other of the fuel and oxidizer from the second compartment.

13. A method of operating a fuel cell having:
a housing providing a first and second compartment separated by a proton exchange membrane, the second compartment having a volume defined at least in part by a degree of expansion of an expandable chamber communicating with the second volume;
a first gas inlet communicating with the first compartment to provide one of a fuel and oxidizer into the first compartment;
a second gas inlet communicating with the second compartment to provide an other of the fuel and oxidizer into the second compartment; and
a gas conduit communicating with the first compartment and the expandable chamber;
the method comprising the steps of:
(a) introducing one of a fuel and oxidizer into the first gas inlet;
(b) introducing an other of the fuel and oxidizer into the second gas inlet and into the expandable chamber via the gas conduit; and
(c) allowing change in volume in the expandable chamber to equalize pressures between the first and second compartment.

14. A method of fabricating a fuel cell of the form having:
a housing providing a first and second compartment separated by a proton exchange membrane, the second compartment having a volume defined at least in part by a degree of expansion of an expandable chamber communicating with the second volume;
a first gas inlet communicating with the first compartment to provide one of a fuel and oxidizer into the first compartment;
a second gas inlet communicating with the second compartment to provide an other of the fuel and oxidizer into the second compartment; and
a gas conduit communicating with the first compartment and the expandable chamber to substantially equalize pressures between the first and second compartment;
the method comprising the steps of:
(a) forming a set of axially stacking elements providing axial gas flow therethrough and having peripheral front and back lips;
(b) forming a set of end cap elements stacking with the axial stacking elements;
(c) forming a proton exchange membrane and flexible diaphragm stacking with the axial stacking elements;
(d) fitting opposed front lips of the first and second element against a peripheral region of the proton exchange membrane to seal thereagainst;
(e) fitting a first end cap against a back lip of the first element opposite the second element to define the first compartment;
(g) fitting an opposed front lip of a third element and back lip of the second element against a peripheral region of the flexible diaphragm on opposite sides thereof to seal thereagainst, the second element, proton exchange membrane, and flexible diaphragm defining the second compartment; and
(h) fitting a second cap against a back lip of the third element, the flexible diaphragm, third element, and second cap defining the expandable chamber.
